(19) United States
(12) Patent Application Publication
(10) Pub. No.: US 2007/0233501 A1
(43) Pub. Date: Oct. 4, 2007

(54) Subscription-based private civil security facilitation method

(76) Inventor: Barrett H. Moore, Winnetka, IL (US)

Correspondence Address: FITCH EVEN TABIN AND FLANNERY, 120 SOUTH LA SALLE STREET, SUITE 1600, CHICAGO, IL, 60603-3406, US

(21) Appl. No.: 11/384,037

(22) Filed: Mar. 17, 2006

(51) Int. Cl. G06Q 10/00; G06Q 30/00

(52) U.S. Cl. 705/1

(57) ABSTRACT

Consideration-based private civil security subscriptions are accepted (101) from subscribers with respect to providing civilly-catastrophic event-based access to at least one life-sustaining resource. That resource is then maintained (103) pending a need to permit subscription-based access to the resource in the event of a catastrophic event. The nature of the subscribed-to resource can vary with the needs or requirements of a given application setting but may comprise one or more of a consumable necessity of human life, a non-consumable necessity of human life, shelter, transportation to effect the above-mentioned access, and/or rescue, to note but a few useful examples. By one approach, these subscriptions may also relate to offering civilly-catastrophic event-based access to one or more non-necessities of human life (including both consumable and non-consumable non-necessities) (102).

### TECHNICAL FIELD

This invention relates generally to providing survival-related services.

### BACKGROUND

Many citizens of the world have long passed the point when a ready availability of the basic necessities of life is satisfactory in and of itself. Today's consumer-oriented citizens demand, and often receive, an incredibly diverse and seemingly ever-growing cornucopia of consuming and experiential options. Such riches are typically based, in turn, upon a highly interdependent series of foundational infrastructure elements. Examples of the latter include, but are certainly not limited to:

transportation infrastructure such as roads, bridges, railways, and so forth that facilitate the inexpensive and rapid movement of sometimes perishable goods from source to consumer;

communications infrastructure such as telephones, television, radio, and the Internet that facilitate the inexpensive and rapid sharing of news, advice, information, and entertainment; and

the totality of civil services such as police services, fire fighting services, medical services, and so forth that facilitate a sufficient degree of order and predictability to, in turn, permit the complex series of inter-related actions that modern society requires in order to operate.

As powerful as the machinery of modern life appears, however, modern citizens are today perhaps more at risk of experiencing a serious disruption in their ability to prosper or even to survive en mass than is generally perceived. Providing the necessities of life in general requires a lot of things to all operate, more or less, correctly. To put it another way, a serious disruption to any significant element of civilized infrastructure can produce catastrophic results for a broad swath of a given civil entity. Any number of natural and/or human-caused events can greatly disrupt society's infrastructure and corresponding ability to provide one or more life-sustaining resources such as water, nutrition, shelter, and the like.

Many people believe and trust that their government (local, regional, and/or national) will provide for them in the event of such a civilly-catastrophic event. And, indeed, in the long view such is clearly a legitimate responsibility owed by any government to its citizens. That such is a consummation devoutly to be wished, however, does not necessarily make it so. Hurricane Katrina provided some insight into just how unprepared a series of tiered modern governmental entities may actually be to respond to even basic survival needs when a civilly-catastrophic event occurs. To a large extent one may reasonably argue that governments have forsaken their responsibility to design, fund, implement, or even discuss an effective civil defense program capable of protecting large segments of their populations.

Such insights, of course, are not particularly new. Civil preparedness shortcomings occasionally attract public attention and niche marketing opportunities exist with respect to provisioning the needs of so-called survivalists. Indeed, there are those who spend a considerable amount of their time and monetary resources attempting to ready themselves to personally survive a civilly-catastrophic event. Therein, however, lies something of a conundrum.

On the one hand, modern governments typically do little to proactively ensure the bulk survival (let alone the comfort) of their citizens in the face of most civilly-catastrophic events. On the other hand, attempting to take responsible actions to reasonably ensure one's own safety and security can become, in and of itself, nearly a fill-time avocation and leave little time to actually enjoy the conveniences and opportunities of modern life. Such individual actions may even be frowned upon by the greater part of society which has grown accustomed and falsely secure with existing efficient just-in-time delivery systems that provide the illusion of plenty while undercutting the perception of risk.

### BRIEF DESCRIPTION OF THE DRAWINGS

The above needs are at least partially met through provision of the subscription-based private civil security facilitation method described in the following detailed description, particularly when studied in conjunction with the drawings, wherein:

FIG. 1 comprises a flow diagram as configured in accordance with various embodiments of the invention;

FIG. 2 comprises a flow diagram as configured in accordance with various embodiments of the invention;

FIG. 3 comprises a schematic block diagram view as configured in accordance with various embodiments of the invention;

FIG. 4 comprises a schematic block diagram as configured in accordance with various embodiments of the invention;

FIG. 5 comprises a flow diagram as configured in accordance with various embodiments of the invention;

FIG. 6 comprises a top plan block diagram view as configured in accordance with various embodiments of the invention; and

FIG. 7 comprises a flow diagram as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, consideration-based private civil security subscriptions are accepted from subscribers with respect to providing civilly-catastrophic event-based access to at least one life-sustaining resource. That resource is then maintained pending a need to permit subscription-based access to the resource in the event of a catastrophic event.

The nature of the subscribed-to resource can vary with the needs or requirements of a given application setting but may comprise one or more of a consumable necessity of human life, a non-consumable necessity of human life, shelter, transportation to effect the above-mentioned access, and/or rescue, to note but a few useful examples. By one approach, these subscriptions may also relate to offering civilly-catastrophic event-based access to one or more non-necessities of human life (including both consumable and non-consumable non-necessities).

These steps are facilitated without dependency upon governmental oversight, participation, or control. The particular resources provided can vary with the needs and requirements of the authorized beneficiaries. Importantly, an individual can take important steps to bring a considerably improved measure of security into their lives without having to effectively become a full-time survivalist; such individuals can, in short, continue to enjoy their chosen vocations and standard of living knowing that, should a civilly-catastrophic event indeed be visited upon them, they will have extraordinary access to one or more resources that are critical to human life.

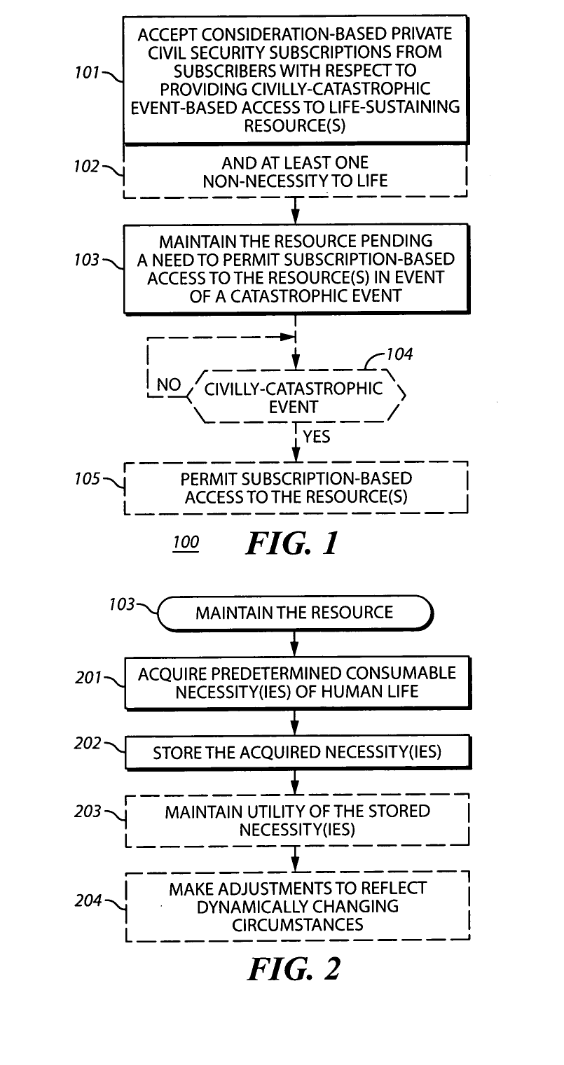

These and other benefits may become clearer upon making a thorough review and study of the following detailed description. Referring now to the drawings, and in particular to FIG. 1, these teachings provide generally for accepting 101 consideration-based private civil security subscriptions from subscribers with respect to providing civilly-catastrophic event-based access to at least one life-sustaining resource (or, if desired, to a plurality of different kinds and/or categories of life-sustaining resources) such as, but not limited to, resources pertaining to hydration, nourishment, shelter, environmentally borne threat abatement (such as protection from chemical, biological, and/or radioactive threats and the like), transportation, and/or rescue services. This life-sustaining resource (or resources) can comprise, for example, a consumable necessity of human life (i.e., a necessity such as nourishment that tends to be reduced in supply as it is consumed) and/or a non-consumable necessity of human life (i.e., a necessity such as shelter that is not necessarily reduced in supply as it is applied or used).

This right of access can pertain, if desired, to a predetermined quantity of the life-sustaining resource. For example, a given subscription can relate to providing access to a one year's supply of the at least one life-sustaining resource for a given individual, number of individuals, or the like.

By one approach, these subscriptions may be accepted by, for example, a for-profit business. By another approach a not-for-profit business (such as a membership-based entity) may be the appropriate entity to offer and accept such subscriptions.

As noted, these teachings provide for a subscription-based approach. As used herein, the term “subscription” shall be understood to refer to and encompass a variety of legal mechanisms. Some relevant examples include, but these teachings are not limited to, subscription mechanisms such as:

time-limited rights of access (as where a subscription provides access rights for a specific period of time, such as one year, in exchange for a corresponding series of payments);

event-limited rights of access (as where a subscription provides access rights during the life of a given subscriber based upon an up-front payment in full and where those access rights terminate upon the death of the subscriber or where, for example, a company purchases a subscription for a key employee and those corresponding rights of access terminate when and if that key employee leaves the employment of that company);

inheritable rights of access (as may occur when the subscription, by its own terms and conditions, provides a right of access that extends past the death of a named subscription beneficiary and further allows for testate and/or intestate transfer to an heir);

rights of access predicated upon a series of periodic payments (as where a subscription provides access rights during, for example, predetermined periods of time on a periodic basis as where a subscriber offers month-by-month payments to gain corresponding month-by-month access rights);

rights of access predicated upon a one-time payment (as may occur when a subscriber makes a single payment to obtain a time-based or event-based duration of access rights or, if desired, when a single payment serves to acquire a perpetual right of access that may be retained, transferred, inherited, or the like);

ownership-based rights of access (as may occur when the subscription provides for ownership rights in the at least one life-sustaining resource);

non-transferable rights of access (as may occur when the subscription, by its terms and conditions, prohibits transfer of the right of access to the at least one life-sustaining resource from a first named beneficiary to another);

transferable rights of access (as may occur when the subscription, by its terms and conditions, permits conditional or unconditional transfer of the right of access to the at least one life-sustaining resource from a first named beneficiary to another);

membership-based rights of access (as may occur when the subscription, by its terms and conditions, establishes a membership interest with respect to the accorded right of access such as, for example, a club-based membership);

fractionally-based rights of access (as may occur when the subscription, by its terms and conditions, establishes a divided or undivided co-ownership interest by and between multiple subscription beneficiaries with respect to a right to access the at least one life-sustaining resource); and/or

non-ownership-based rights of access (as may occur when the subscription, by its terms and conditions, establishes the aforementioned right of access via, for example, a lease, rental, or borrowing construct).

If desired, a plurality of differentiated subscription opportunities can be offered in this regard. This plurality of differentiated subscription opportunities can correspond, for example, to providing access to differing life-sustaining resource supplies. As but one very simple illustration in this regard, such subscription opportunities can differ from one another at least with respect to cost. This, in turn, provides subscriber choice with respect to selecting a particular subscription that best meets their specific needs and/or budget limitations. For example, one subscription can provide for accessing life-sustaining resources that, though nutritionally viable, are economically selected while another subscription might provide for life-sustaining resources that are more costly and in turn reflect, for example, a wider variety of choices within a given category of resource.

These teachings also readily encompass the notion of a given subscriber providing such a subscription for an authorized beneficiary other than themselves. Such might occur, for example, when one family member procures such a subscription for one or more other family members. Another example would be for a company to subscribe on behalf of named key employees, family members of such key employees, and so forth. Other examples no doubt exist.

As noted, these subscriptions relate to providing access to one or more life-sustaining resources in the event of a civilly-catastrophic event. Such access may be predicated, if desired, upon a requirement that the civilly-catastrophic event be one that persists in substantial form for more than a predetermined period of time (such as one hour, one day, one week, and so forth) or that causes at least a predetermined amount or degree of infrastructure impairment or other measurable impact of choice.

As used herein, “civilly-catastrophic event” will be understood to refer to an event that substantially and materially disrupts a society's local, regional, and/or national infrastructure and ability to provide in ordinary course for the at least one life-sustaining resource that is the subject of the subscription. Such a civilly-catastrophic event can include both a precipitating event (which may occur over a relatively compressed period of time or which may draw out over an extended period of time) as well as the resultant aftermath of consequences wherein the precipitating event and/or the resultant aftermath include both the cause of the infrastructure interruption as well as the continuation of that interruption.

A civilly-catastrophic event can be occasioned by any of a wide variety of natural and/or human-caused disasters. Examples of natural disasters that are potentially capable of initiating a civilly-catastrophic event include, but are not limited to, extreme weather-related events (such as hurricanes, tsunamis, extreme droughts, widespread or unfortunately-targeted tornadoes, extreme hail or rain, and the like, flooding, an ice age, and so forth), extreme geological events (such as earthquakes, volcanic activity, and so forth), extreme space-based collisions (as with comets, large asteroids, and so forth), extreme environmental events (such as widespread uncontrolled fire or the like), and global or regional pandemics, to note but a few.

Examples of human-caused disasters capable of initiating a civilly-catastrophic event include both unintended events as well as intentional acts of war, terrorism, madness or the like. Examples of human-caused disasters capable of such potential scale include, but are not limited to, nuclear-related events (including uncontrolled fission or fusion releases, radiation exposure, and so forth), acts of war, the release of deadly or otherwise disruptive biological or chemical agents or creations, and so forth.

In addition to accepting 101 a subscription with respect to providing civilly-catastrophic event-based access to one or more consumable or non-consumable life-sustaining resources, a given subscription may also provide for similar access to at least one non-necessity 102 (that is, an item or service that is not, strictly speaking, necessary to sustain human life on an elemental basis). This can certainly comprise providing a right of access to a plurality of non-necessities if desired. An illustrative listing of representative non-necessities comprises, but is certainly not limited to:

a luxury consumable (such as, for example, alcoholic beverages, foods that provide an experience beyond simple survival, and so forth);

a luxury non-consumable;

clothing;

a food preparation tool;

a personal communication device;

a personal hygiene item;

non-human nourishment (such as dog food, cat food, and so forth);

barter medium (such as bulk or coined precious metals including but not limited to gold, silver, and so forth);

an electrical energy source (including but not limited to alternating current power sources, direct current power sources, fuel-consumptive power sources, renewable fuel source power sources, and so forth);

an entertainment apparatus (such as game stations, musical instruments, reading material, and so forth);

an educational tool (including but not limited to instructional texts, reference works, laboratory and demonstrative equipment, and so forth);

physical conditioning, exercise, and maintenance training and equipment;

repair and maintenance tools and services;

crafts supplies and training; and/or

sports equipment and facilities;

to note but a few examples.

This process 100 then provides for maintaining 103 the resource(s) pending a need to permit subscription-based access to the resource(s) in response to the occurrence of a catastrophic event. This, of course, can comprise maintaining the resource on behalf of the subscriber and/or on behalf of another authorized beneficiary. The specifics of such maintenance will of course vary with respect to the nature of the resource or resources being maintained.

As one example, and referring momentarily to FIG. 2, when the resource (or resources) comprise one or more predetermined consumable necessities of human life, maintaining 103 the resource can comprise acquiring 201 the at least one predetermined consumable necessity of human life to thereby provide acquired necessities and then storing 202 those acquired necessities to thereby provide stored necessities that are held on behalf of the corresponding authorized beneficiaries pending a need to access those stored necessities in the event of a triggering civilly-catastrophic event. These acquisition and storing steps can further comprise, if desired, acquiring and storing non-consumable necessities of human life and/or consumable or non-consumable non-necessities of human life.

Acquisition 201 of such items can be achieved through any of a variety of means. By one approach the items may be procured on the open market. By another approach the items may be purchased or otherwise acquired from third parties via private negotiations. By yet another approach the entity that provides and accepts these subscriptions may itself create (through manufacturing, farming, or the like) the items of interest. In some cases the acquired item may comprise a staple of ordinary commerce. In other cases the acquired item may be unique and/or proprietary to the acquiring/storing entity.

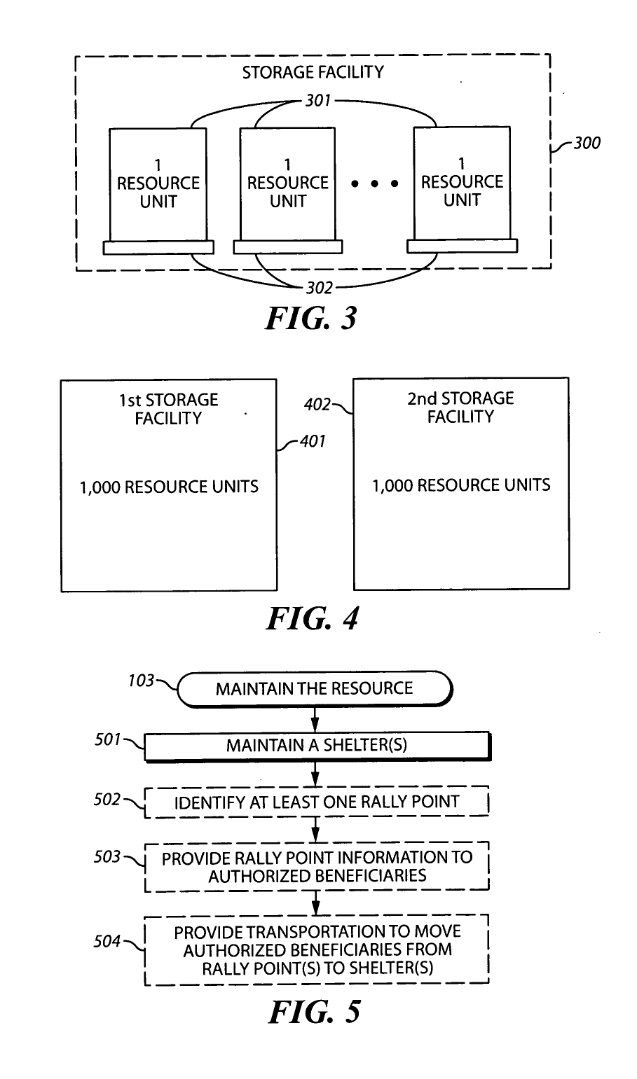

With momentary reference to FIG. 3, by one approach such storage 202 occurs through use of one or more storage facilities 300 that are owned or controlled by the subscription accepting entity. Any suitable storage facility may be used for this purpose with examples comprising (but not being limited to) above ground man-made shelters, below ground or below water facilities (including purposefully excavated facilities, natural caverns, and so forth), and water borne facilities (such as barges and the like). Each such storage facility 300 will likely serve to store the resources as correspond to a plurality of authorized beneficiaries. By one approach such resources are stored in the aggregate. By another approach, or in combination with an aggregated approach, some or all of the acquired necessities are stored in subscriber-based bundles 301. For example, each such bundle 301 can comprise a one year supply of all acquired items for a single adult authorized beneficiary. As another example, such a bundle 301 could comprise a one year supply of all acquired items as are intended for a family of four authorized beneficiaries.

Other possibilities of course exist. For example, a single authorized beneficiary may have a first bundle comprised of staple items that are acquired and stored for all beneficiaries and a second bundle comprised of custom items that are specifically and uniquely acquired for this particular beneficiary or class of beneficiaries (such as beneficiaries who all share a common dietary ailment or condition, sensitivity, medical condition, preference, or the like).

The bundle 301 itself can be realized via any of a wide variety of encapsulating or restraining mechanisms. For example, a tarp and tie-downs can be used to segregate the goods and form the described bundle. As another example, discrete storage cabinets formed of wood, metal, plastic, canvas, or other material of choice could be employed for this purpose. Shrink wrap materials could also be employed in this regard. In addition, if desired, these bundles 301 can be individually palletized (i.e., each placed upon and optionally secured to a pallet 302). Palletization, in turn, will permit ready and efficient movement of such bundles 301 to, about, or from a given storage facility 300 and/or delivery of such a bundle to an authorized beneficiary when such delivery comprises the desired form of granting access to such resources.

The use of such bundles (and particularly the bundling of staple items in a manner calculated to provide at least a minimum level of survival support to a predetermined number of authorized beneficiaries for at least a predetermined period of time) provides highly leveragable resource allocation opportunities as well. For example, and referring now momentarily to FIG. 4, a first storage facility 401 may contain 1,000 such storage units while a second storage facility 402 may contain an additional 1,000 such storage units. By treating such storage units, at least in part, as being fungible with one another, such resources can be made available to authorized beneficiaries in time of need by accessing a storage facility that is positioned to provide the earliest relief to the beneficiaries rather than by necessarily requiring all beneficiaries to only access their resources from a specific pre-ordained facility.

Referring again to FIG. 2, maintaining 103 the resource in such a context can further optionally comprise maintaining 203 the utility of the stored necessities. This can comprise, for example, monitoring the usability of perishable items and replacing such items on a corresponding schedule. As another simple illustration this step 203 can comprise holding certain items in deep refrigeration or in other special storage conditions as may suit the proper maintenance of such items.

Such maintenance 103 can also optionally comprise making adjustments 204 to the stored necessities to reflect dynamically changing circumstances as occur during the consideration-based private civil security subscription period. As one illustration, a new product may become available that is particularly useful in treating a particular infectious condition that may likely arise upon the occurrence of a particular kind of civilly-catastrophic event. In such a case, maintaining 103 such resources can readily accommodate updating the acquired and stored items to include a supply of this new product. Accordingly, this step of making adjustments 204 can readily comprise one or more of removing a particular one of the stored necessities (as when a better substitute becomes available, when the stored necessity itself is shown to be less effective for its intended purpose than was originally thought, and so forth), adding additional ones of the stored necessities (as when it becomes subsequently understood that more of a particular item is desirable to achieve a particular survival-related goal or purpose), adding at least one new stored necessity that is not already stored (as illustrated in the example provided above), and so forth.

In the examples provided above, the resource being acquired and maintained comprises consumable or non-consumable items. As noted earlier, however, these teachings are applicable for use with other resources as well. For example, and referring now to FIG. 5, maintaining 103 the resource may relate to providing civilly-catastrophic event-based access to a shelter. By this approach this step of maintaining 103 the resource can comprise maintaining 501 such a shelter.

Much is known in the art regarding construction and maintenance of shelters. Such a construction will usually at least serve to protect the inhabitants from environmental stress and extremes. In addition to walls and a roof such a shelter will typically also comprise internal temperature control, lighting, storage facilities, sleeping facilities, food preparation facilities, personal hygiene facilities, and so forth. For present purposes such a shelter may also be equipped to provide for water treatment (such as filtering, bacteria removal, and so forth), waste treatment and/or recycling, electrical power generation, and/or air treatment (including but not limited to conditioning, filtering, and so forth). By one approach such a shelter can also be equipped with communication facilities including a variety of wireless broadcast capabilities, long-distance two-way communications capabilities, and so forth.

By yet another approach, such a shelter can provide private safe deposit box service for the authorized beneficiaries. This, in turn, would permit beneficiaries to pre-provision such a shelter with certain personal items of their choice and/or to have a safe place to store their own valuables upon arriving at the shelter during times of need.

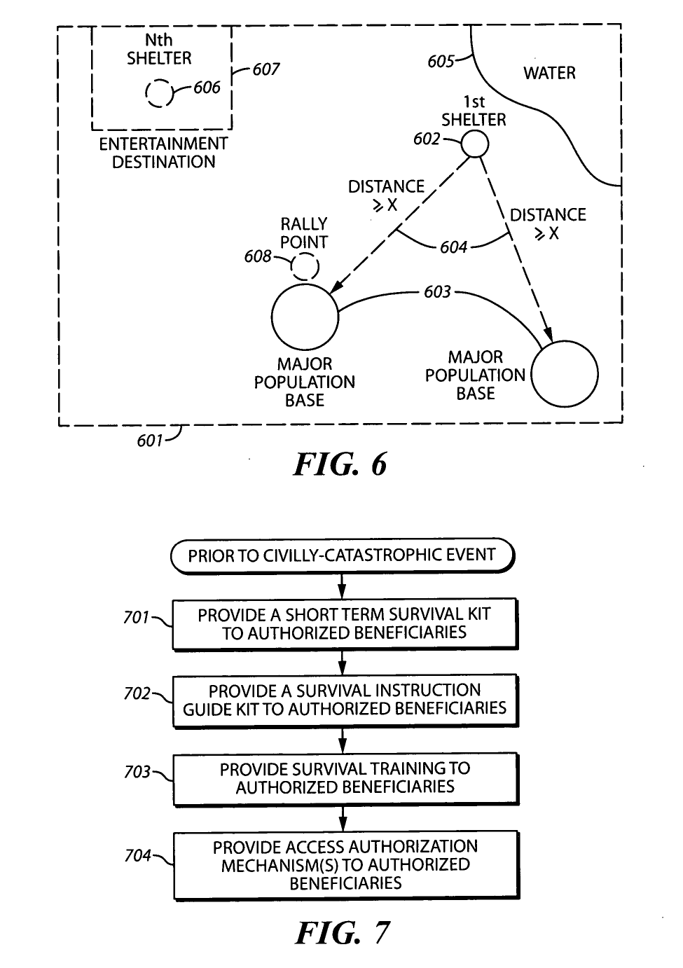

Security will likely comprise a primary concern for such a shelter. In particular it will likely be important to secure the shelter, any resources as are stored or otherwise available at the shelter, and the inhabitants of the shelter from unauthorized entry and access. By one approach, this can comprise maintaining the shelter in a location that is substantially distal from a nearest substantial human population. For example, and referring momentarily to FIG. 6, within a given geographic region 601 (such as a continent, country, or the like) a shelter 602 may be separated from the closest major population bases 603 by a distance that at least exceeds some predetermined substantial distance X 604. Depending upon other factors, this distance X might comprise, for example, 800 kilometers. Other factors might well play a part in this regard, of course. For example, a significant natural barrier (such as a large mountain range) might lie between a major population base and a shelter and make reasonable a shorter separation distance between such entities.

When possible, and with continued reference to FIG. 5, it may be desirable to locate such a shelter 602 in relative proximity to a water source 605. A suitable water source 605 can comprise a ground-level water source or an underground water source as, in either case, ready access to the water source may be available. This, in turn, can be useful with respect to ensuring an adequate supply of water for the inhabitants of the shelter 602 in times of need. A ground-level water source may also provide a means of ingress and egress to facilitate the comings and goings of the authorized beneficiaries (for example, a navigable waterway can provide an effective pathway by which to transport authorized beneficiaries to the shelter 602).

Notwithstanding that it may be desirable to locate such shelters at a considerable distance from major population centers, this does not necessarily require that such shelters be secreted within completely primitive and/or wild settings. For example, one useful approach might be to locate such a shelter 606 proximal to an entertainment destination 607 (such as, but not limited to, remotely located golf courses, resorts, dude ranches, casinos, and so forth). In such a case at least some of the infrastructure that may be required and/or useful for the shelter can be shared with the facilities of the entertainment destination and thereby reduce the effective costs of installing and maintaining such facilities.

For a variety of reasons it may be appropriate to provide a plurality of such shelters in various locations throughout a relatively wide geographic region such as a continent or country. Such a dispersal can aid with reducing the logistic difficulties of transporting authorized beneficiaries to such a shelter during times of need. Dispersed shelters can also help ensure that at least some shelters will more likely survive civilly-catastrophic events that pose sufficient destructive force to destroy such a shelter.

When providing a plurality of shelters, it may also be useful to differentiate such shelters from one another with respect to, for example, their features and/or accouterments. Such shelters may be differentiated, for example, with respect to their relative support for such things as a maximum supportable population, a depth and breadth of provided non-essential accouterments of life, medical facilities (such as, but not limited to, specialized equipment such as respirators, dialysis equipment, operating facilities, and so forth), pet animal accommodations, risk threat abatement capability, entertainment facilities, and so forth. Assignment and/or access to a given differentiated shelter can be determined, at least in part, by such things as relative initial proximity of the authorized beneficiary, the terms and conditions of the corresponding subscription agreement, and so forth.

By one approach these teachings can be simply practiced by provision of shelter and/or life-sustaining supplies; gaining physical access to such resources comprises the responsibility of the authorized beneficiaries. During such times, of course, it can be expected that civil conditions will be troubled and confusing. Therefore, by another approach these teachings can further encompass transporting at least some of the authorized beneficiaries to the shelter and/or supplies in response to the occurrence of a civilly-catastrophic event. There are various ways by which to accomplish such a task.

Referring again to FIG. 5, by one optional approach at least one rally point can be identified 502. (An example of such a rally point appears in FIG. 6 as denoted by reference numeral 608.) Such a rally point need not be reserved only for this purpose and may, for example, simply comprise a convenient location for at least some authorized beneficiaries. Example rally points might include sports stadiums and auditoriums, amusement parks, and the like. When possible, it may be helpful to locate such a rally point relatively near an airstrip and/or a navigable waterway. Such amenities, in turn, can potentially be used when transporting the gathered beneficiaries to their destination (as when, for example, a destination shelter is accessible from the navigable waterway that is also readily accessible from the rally point).

By one approach, one or more such rally points can be identified for each larger population area that contains authorized beneficiaries. It would also be possible, of course, to identify rally points to serve a similar function in more rural settings as well if desired.

This process can then optionally provide 503 information regarding such rally points to the authorized beneficiaries. This information can be provided prior to the occurrence of a civilly-catastrophic event if desired. It may also be useful or possible to provide such information (either in the first instance or as a supplemental notice) following the initiation of such an event. The latter may be achieved using such communication means as may be available at the time. It would also be possible to provision each authorized beneficiary (or family or company of beneficiaries) with one or more communications devices by which such information could be provided. This process could then provide 504 appropriate transportation to move the authorized beneficiaries from these rally points to the destination (such as to a designated shelter).

In many instances such transportation can comprise standard vehicles (cars, buses, boats, airplanes, railroad cars, and so forth). If desired, however, more specialized equipment could be used including but not limited to armored transports, environmentally-contained vehicles or trailers, and so forth.

These teachings can readily accommodate other features as well. For example, and referring now to FIG. 7, prior to the occurrence of a civilly-catastrophic event an authorized beneficiary can be provided 701 with a short-term survival kit to facilitate their survival prior to their being able to access the aforementioned stored necessities upon the occurrence of a civilly-catastrophic event. Such a short-term survival kit might comprise, for example, a seven day supply of nourishment, clothing, food preparation items, bedding, navigation tools, communication tools and/or location beacons, first aid supplies, water treatment items, items to aid with protecting against or otherwise treating environmentally borne hazards, maps, portable power sources, fire starting equipment, survival instructions, and so forth.

As another example, authorized beneficiaries could be provided 702 with a survival instruction guide kit. These instructions could provide information regarding survival practices, emergency responses, and so forth. By one approach each authorized beneficiary who comprised a part of a shared group (such as a family group, a company group, and so forth) would receive such a kit. This, in turn, would facilitate unity of action, purpose, and result in the event of a civilly-catastrophic event. For example, by each knowing and observing the shared instructions provided by such an approach, the participants would be able to take their own coordinated actions while being relatively secure in their knowledge of what their group counterparts were also likely doing at that time.

This survival instruction guide kit could comprise, for example, a book or manual having printing survival instructions and information in combination with fill-in-the-blank opportunities whereby a given authorized beneficiary could customize the instructions to specifically suit their particular needs and situation. Such blanks could be used, for example, to prompt the beneficiary to think through and to record information such as their primary and secondary rally points or other family/group meeting points and protocols, communications protocols and contact information, specific items (perhaps somewhat unique to the individual and which may, or may not, relate to the survival of that individual) that should be stockpiled or otherwise made readily available in the event of a civilly-catastrophic event, and so forth. Such a book or manual could include indexes, tabs, or other navigation tools to permit a reader to quickly find the relevant information they require during a time of need.

These teachings would also accommodate providing 703 survival training to authorized beneficiaries. Such training could comprise in-person, on-site training, live instructors, and/or previously prepared teaching resources such as, but not limited to, electronic learning resources. This training could include both general information regarding specific do's and don'ts as pertain to different kinds of civilly-catastrophic events as well as more specific information regarding specific actions that should be taken by the authorized beneficiary with respect to successfully achieving access to their subscribed-to resources as per their subscription.

These teachings will also accommodate providing 704 authorized beneficiaries with a corresponding authorization mechanism by which they can effect their right of access to the resources provided by their subscription. This may comprise a mechanism that the beneficiary carries with them as personal property (such as an identification card) or, for example, a biometric-based identity authentication process that relies upon fingerprints, retinal patterns, or some other relatively unique aspect of the human body.

It will be appreciated that these teachings provide for a highly flexible yet powerfully effective way by which a modern citizen can greatly improve their likelihood of surviving a civilly-catastrophic event. These teachings are sufficiently flexible so as to accommodate the needs and desires of a wide-ranging set of potential beneficiaries while nevertheless still tending to ensure adequate access to the basic necessities of life. Though training and some related activity may be provided and encouraged, in general the beneficiary receives these benefits without being required to make the commitment of time, energy, and expertise that would ordinarily be associated with attaining such a high level of civil security.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A method comprising:
accepting consideration-based private civil security subscriptions from subscribers with respect to providing civilly-catastrophic event-based access to at least one life-sustaining resource;
maintaining the resource pending a need to permit subscription-based access to the resource in event of a catastrophic event.

2. The method of claim 1 wherein accepting consideration-based private civil security subscriptions from subscribers comprises accepting the consideration-based private civil security subscriptions at a for-profit business.

3. The method of claim 1 wherein the subscriptions comprise at least one of:
time-limited rights of access;
event-limited rights of access;
inheritable rights of access;
rights of access predicated upon a series of periodic payments;
rights of access predicated upon a one-time payment;
ownership-based rights of access;
non-transferable rights of access;
transferable rights of access;
membership-based rights of access;
fractionally-based rights of access;
non-ownership-based rights of access.

4. The method of claim 1 wherein accepting consideration-based private civil security subscriptions from subscribers with respect to providing civilly-catastrophic event-based access to at least one life-sustaining resource comprises accepting consideration-based private civil security subscriptions from subscribers with respect to providing civilly-catastrophic event-based access to a plurality of life-sustaining resources.

5. The method of claim 4 wherein accepting consideration-based private civil security subscriptions from subscribers with respect to providing civilly-catastrophic event-based access to a plurality of life-sustaining resources comprises accepting consideration-based private civil security subscriptions from subscribers with respect to providing civilly-catastrophic event-based access to a plurality of life-sustaining resources as pertain to a plurality of differing categories of life's necessities.

6. The method of claim 1 wherein the at least one life-sustaining resource comprises at least one of:
hydration;
nourishment;
shelter;
environmentally borne threat abatement.

7. The method of claim 1 wherein the civilly-catastrophic event comprises an event that substantially disrupts society's infrastructure and ability to provide the at least one life-sustaining resource.

8. The method of claim 7 wherein the civilly-catastrophic event is one that persists in substantial form for more than a predetermined period of time.

9. The method of claim 7 wherein the civilly-catastrophic event comprises at least one of:
a natural disaster;
a human-caused disaster.

10. The method of claim 9 wherein the natural disaster comprises at least one of:
a severe weather event;
a severe geophysical event;
a large object impacting the Earth;
a severe disease-based event;
a severe natural shortage of a life-sustaining resource.

11. The method of claim 9 wherein the human-caused disaster comprises at least one of:
warfare;
an act of terrorism;
an accident that results in public dispersal of a severe environmentally borne danger.

12. The method of claim 1 wherein the at least one life-sustaining resource comprises at least one of:
a consumable necessity of human life;
a non-consumable necessity of human life.

13. The method of claim 1 wherein accepting consideration-based private civil security subscriptions from subscribers with respect to providing civilly-catastrophic event-based access to at least one life-sustaining resource further comprises accepting consideration-based private civil security subscriptions from subscribers with respect to providing civilly-catastrophic event-based access to at least one non-necessity.

14. The method of claim 13 wherein the at least one non-necessity comprises a plurality of non-necessities.

15. The method of claim 13 wherein the at least one non-necessity comprises at least one of:
a luxury consumable;
a luxury non-consumable;
clothing;
a food preparation tool;
a personal communication device;
a personal hygiene item;
non-human nourishment;
barter medium;
an electrical energy source;
an entertainment apparatus;
an educational tool;
physical conditioning, exercise, and maintenance training and equipment;
repair and maintenance tools and services;
crafts supplies and training;
sports equipment and facilities.

16. The method of claim 1 wherein accepting consideration-based private civil security subscriptions from subscribers with respect to providing civilly-catastrophic event-based access to at least one life-sustaining resource comprises accepting consideration-based private civil security subscriptions from subscribers with respect to providing civilly-catastrophic event-based access to at least a predetermined quantity of the at least one life-sustaining resource.

17. The method of claim 16 wherein the predetermined quantity comprises a one year's supply of the at least one life-sustaining resource.

18. The method of claim 1 wherein accepting consideration-based private civil security subscriptions from subscribers with respect to providing civilly-catastrophic event-based access to at least one life-sustaining resource comprises providing a plurality of differentiated subscription opportunities that correspond to differing life-sustaining resource supplies.

19. The method of claim 18 wherein the differentiated subscription opportunities differ from one another at least with respect to cost.

20. The method of claim 1 wherein accepting consideration-based private civil security subscriptions from subscribers with respect to providing civilly-catastrophic event-based access to at least one life-sustaining resource comprises accepting consideration-based private civil security subscriptions from subscribers with respect to providing civilly-catastrophic event-based access by predetermined authorized beneficiaries to at least one life-sustaining resource

21. The method of claim 20 wherein maintaining the resource pending a need to permit subscription-based access to the resource in event of a catastrophic event comprises storing the resource to provided stored necessities that are held on behalf of the authorized beneficiaries pending a need to access the stored necessities upon occurrence of the civilly-catastrophic event.

22. The method of claim 21 wherein accepting consideration-based private civil security subscriptions from subscribers with respect to providing civilly-catastrophic event-based access to at least one life-sustaining resource further comprises accepting consideration-based private civil security subscriptions from subscribers with respect to providing civilly-catastrophic event-based transport service.

23. The method of claim 22 wherein accepting consideration-based private civil security subscriptions from subscribers with respect to providing civilly-catastrophic event-based access to at least one life-sustaining resource further comprises accepting consideration-based private civil security subscriptions from subscribers with respect to providing civilly-catastrophic event-based rescue service.

24. The method of claim 1 wherein:
accepting consideration-based private civil security subscriptions from subscribers with respect to providing civilly-catastrophic event-based access to at least one life-sustaining resource comprises accepting consideration-based private civil security subscriptions from subscribers with respect to providing civilly-catastrophic event-based access to at least one predetermined consumable necessity of human life; and
maintaining the resource pending a need to permit subscription-based access to the resource in event of a catastrophic event comprises:
acquiring the at least one predetermined consumable necessity of human life to provide acquired necessities;
storing the acquired necessities to provided stored necessities that are held on behalf of the authorized beneficiaries pending a need to access the stored necessities in event of the civilly-catastrophic event.

25. The method of claim 24 wherein maintaining the resource further comprises managing the stored necessities to facilitate at least one of:
maintaining utility of the stored necessities;
making adjustments to the stored necessities to reflect dynamically changing circumstances as occur during the consideration-based private civil security subscription.

26. The method of claim 25 wherein making adjustments to the stored necessities comprises at least one of:
removing a particular one of the stored necessities;
adding additional ones of the stored necessities;
adding at least one new stored necessity that is not already stored.

27. The method of claim 24 wherein consideration-based private civil security subscriptions from subscribers with respect to providing civilly-catastrophic event-based access to at least one predetermined consumable necessity of human life further comprises accepting consideration-based private civil security subscriptions from subscribers with respect to providing civilly-catastrophic event-based access to at least one predetermined consumable non-necessity of human life.

28. The method of claim 24 wherein storing the acquired necessities comprises storing the acquired necessities at a secure facility.

29. The method of claim 28 wherein storing the acquired necessities at a secure facility comprises, at least in part, storing the acquired necessities at a secure facility that is substantially distal from a substantial human population.

30. The method of claim 29 wherein storing the acquired necessities at a secure facility that is substantially distal from a substantial human population further comprises storing the acquired necessities at a secure facility that is proximal to an entertainment destination.

31. The method of claim 24 wherein storing the acquired necessities to provided stored necessities comprises storing the stored necessities in bundles on a subscriber-by-subscriber basis.

32. The method of claim 31 wherein the bundles are palletized.

33. The method of claim 24 wherein storing the acquired necessities to provided stored necessities comprises storing the stored necessities using storage facilities that are located at least a substantial distance from one another.

34. The method of claim 24 further comprising:
providing to the authorized beneficiaries, prior to the civilly-catastrophic event, a short-term survival kit to facilitate survival of the authorized beneficiaries prior to their accessing the stored necessities following initiation of the civilly-catastrophic event.

35. The method of claim 24 further comprising:
providing to the authorized beneficiaries, prior to the civilly-catastrophic event, a survival instruction guide kit.

36. The method of claim 35 wherein the survival instruction guide kit comprises, at least in part, a hardcopy manual containing survival instructions to be observed by the authorized beneficiaries.

37. The method of claim 36 wherein the hardcopy manual further comprises information blanks to be filled in by the authorized beneficiaries to thereby personalize the survival instructions with specific information relevant to the survival needs of individual authorized beneficiaries.

36. The method of claim 24 further comprising:
providing to the authorized beneficiaries, prior to the civilly-catastrophic event, survival training.

37. The method of claim 36 wherein providing the survival training comprises, at least in part, providing the authorized beneficiaries with access to electronic learning resources.

38. The method of claim 1 wherein:
accepting consideration-based private civil security subscriptions from subscribers with respect to providing civilly-catastrophic event-based access to at least one life-sustaining resource comprises accepting consideration-based private civil security subscriptions from subscribers with respect to providing authorized beneficiaries civilly-catastrophic event-based access to a shelter; and
maintaining the resource pending a need to permit subscription-based access to the at least one life-sustaining resource in event of a catastrophic event comprises maintaining the shelter pending a need to permit subscription-based access to the shelter in event of the civilly-catastrophic event.

39. The method of claim 38 wherein maintaining the shelter further comprises maintaining the shelter at a secure facility.

40. The method of claim 39 wherein maintaining the shelter at a secure facility comprises maintaining the shelter at a secure facility that is substantially distal from a substantial human population.

41. The method of claim 40 wherein maintaining the shelter at a secure facility that is substantially distal from a substantial human population further maintaining the shelter at a secure facility that is proximal to an entertainment destination.

42. The method of claim 38 wherein maintaining the shelter further comprises maintaining a plurality of shelters that are separated from one another by at least a substantial distance.

43. The method of claim 42 wherein the plurality of shelters are differentiated from one another with respect to at least one of:
supportable population;
non-essential accoutrements of life;
medical facilities;
pet animal accommodations;
risk threat abatement capability
entertainment facilities.

44. The method of claim 38 wherein maintaining the shelter comprises maintaining a shelter that provides at least one of:
water treatment;
waste treatment;
air treatment;
proximity to water;
self-replenishment capability;
long distance communications facilities.

45. The method of claim 38 wherein maintaining the shelter comprises maintaining a shelter that provides private safe deposit box service for the authorized beneficiaries.

46. The method of claim 38 further comprising:
providing information to the authorized beneficiaries regarding rally points to which the authorized beneficiaries are to travel in event of the civilly-catastrophic event.

47. The method of claim 46 further comprising:
providing transportation to move the authorized beneficiaries from the rally points to the shelter.
